(19) United States
(12) Patent Application Publication
(10) Pub. No.: US 2003/0116883 A1
(43) Pub. Date: Jun. 26, 2003

(54) Apparatus and method for forming a molding trim

(75) Inventor: Jim Thiessen, Savgus, CA (US)

Correspondence Address: OPPENHEIMER WOLFF & DONNELLY, 2029 Century Park East, 38th Fl., Los Angeles, CA, 90067, US

(73) Assignee: GRUBER SYSTEMS, INC.

(21) Appl. No.: 10/029,481

(22) Filed: Dec. 20, 2001

(51) Int. Cl. B29C 33/40; B29C 33/60

(52) U.S. Cl. 264/219; 264/338; 425/470

(57) ABSTRACT

Apparatus and method for forming a molding trim, such as a simulated coiled rope, including forming a mold having raised and depressed areas and placing an uncured material into the mold thereby forming raised and depressed areas in the material simulating a coiled rope or the like.

### BACKGROUND OF THE INVENTION

1. Field of the Invention

The invention relates to trim molding, as for vanities, tubs, panels, etc. and the like, and to apparatus and method for forming decorative trims.

2. Related Art

Certain molded products, such as bathroom vanities, tubs, panels, etc. and the like, may have a decorative trim about the periphery thereof. There is a need for a quick and easy way of forming a molded trim in an uncured material, such as a polymer material, which can be carried out at the place of manufacture of the product to which the trim is to be applied and, when cured, forms a hardened product, such as cultured resin, simulated marble or simulated granite.

### INVENTION SUMMARY

It is an object of this invention to provide an apparatus and method for forming a decorative trim for vanities, tubs, panels, or the like.

It is still further an object of this invention to provide a mold for forming a trim in uncured material.

It is still another object of this invention to provide an apparatus and method for forming a decorative trim simulating coils of a rope.

These and other objects are preferably accomplished by providing a mold used to form a molding trim, such as simulated coiled rope, including forming the mold to have raised and depressed areas and placing an uncured material into the mold thereby forming raised and depressed areas in the material when cured in situ thus simulating a coiled rope or the like.

### BRIEF DESCRIPTION OF THE DRAWINGS

FIG. 1 is an exploded perspective view of a mold and a strip of cured material formed in accordance with the teachings of the invention;

FIG. 2 is a top plan view of the mold alone of FIG. 1;

FIG. 3 is an end view of the mold of FIG. 2 showing a strip of material curing in the mold; and

FIG. 4 is a top plan view of the molded portion of the strip of FIG. 3 after curing and removal from the mold.

### DETAILED DESCRIPTION OF THE PREFERRED EMBODIMENTS

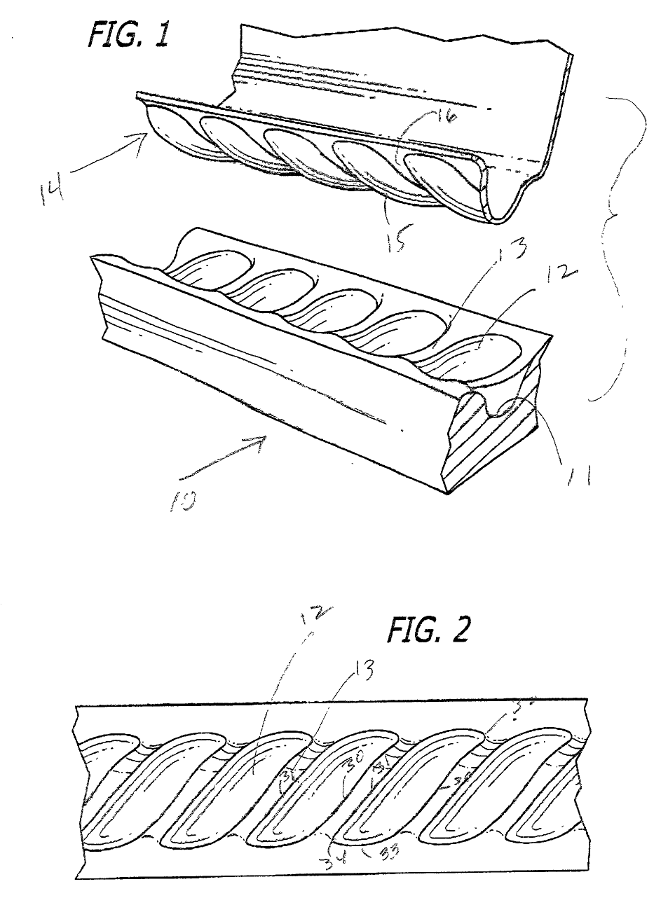

Referring now to FIG. 1 of the drawing, a mold 10 is shown. Although various materials may be used for the mold, preferably the mold is of a flexible material, such as urethane elastomer. Such a material provides some ability of the mold to flex or move when molding a composite strip, such as strip 14 (FIG. 1), as will be discussed. Although other materials such as aluminum may be used, such a rigid material would not move or flex and might scratch the surface of the mold 10 as will be discussed.

Thus, mold 10 is an elongated generally rectangular block of material having a cavity 11 therein along its longitudinal axis. Cavity 11 has a plurality of depressions 12 therealong which may simulate coils of a rope or the like. Each successive depression may be separated from an adjacent depression 12 by a raised wall 13. Thus, the depressions 12 and walls 13 simulate hills and valleys which, when applied to a strip of uncured material, such as strip 14 (FIG. 1), form, when cured in situ, a plurality of spaced raised surfaces 15, separated by equally spaced depressions 16 simulating a rope or the like.

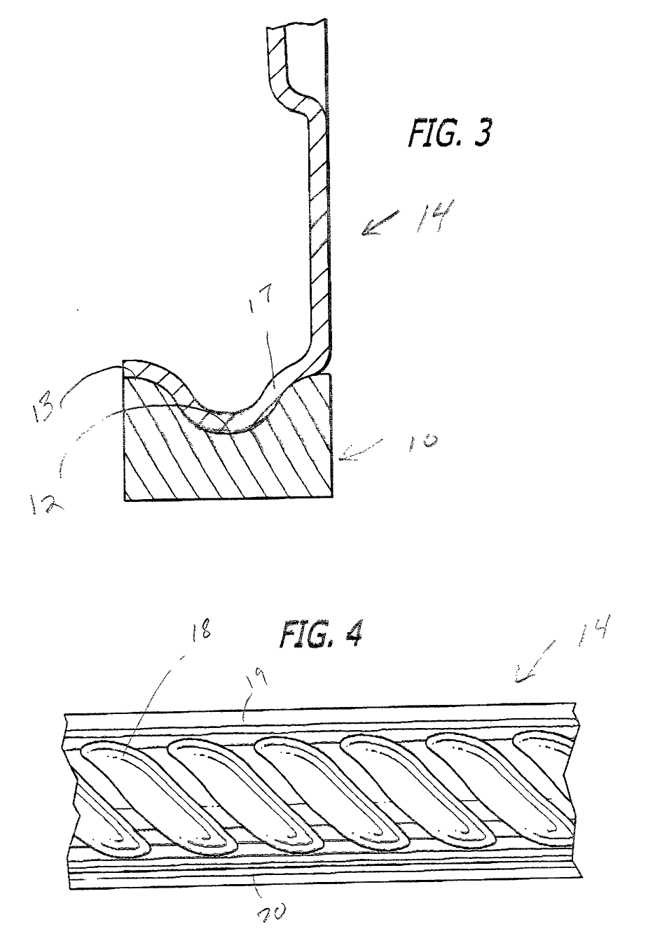

Thus, the strip of material 14 (FIG. 1), which can be of any size or length, has a portion 17 (see also FIG. 3) which is placed in mold 10 in its uncured state. When it cures, it assumes the contours of mold 10 as seen in FIGS. 1 and 4.

A suitable paste release wax may be may be applied to mold 10 prior to forming the strip 14 therein. When the strip 14 sets or cures, the result, as shown in FIGS. 1 and 4, is a molding or trim in the distinctive form of a rope having a plurality of coils.

Of course, the rope design can be varied depending on the configuration of the raised and depressed areas 12, 13 of mold 10. The resulting rope trim shown in FIG. 4 has a distinctive coiled rope design 18 along strip 14 with plain areas 19, 20 on each side thereof forming a distinctive design.

It can be seen in FIG. 2 that each depression 12 extends generally oblique to the longitudinal axis of mold 10 and is formed by a pair of generally spaced parallel lines 30, 31. One of the lines, such as line 31, curves at one end and meets the other line 30 at a point 32. Line 30, at its other end, curves at 33 to meet line 31 at point 34.

Any suitable uncured material, such as a polymer material, may be used poured into the mold in its uncured state. It will cure in situ forming a solid contoured piece. Thus, the techniques disclosed herein can be used to form a cultured resin material, such as a simulated marble or granite material, fiberglass, etc. The final product can be a vanity, tub, panel, bowl, decorative strip, etc.

Although a particular embodiment of the invention is disclosed, variations thereof may occur to an artisan and the scope of the invention should only be limited by the scope of the appended claims.

We claim:

1. A method for forming a decorative trim of cured material comprising the steps of:
forming an elongated mold of relatively solid and flexible material;
forming a plurality of spaced raised and depressed portions in a cavity extending along one elongated side of said mold; and
placing an uncured material into said spaced raised and depressed portions of said mold and allowing said material to cure thereby forming an elongated strip of cured material having a contoured outer surface conforming to the spaced raised and depressed portions of said mold.

2. The method of claim 1 including the step of applying a paste release wax to the surfaces of said mold along said cavity prior to placing said material therein.

3. The method of claim 1 wherein the step of forming said mold includes the step of forming said mold out of an elastomeric material.

4. The method of claim 1 wherein the steps of forming spaced raised and depressed portions in a cavity of said mold include the step of forming a plurality of spaced depressions extending oblique to the longitudinal axis of said mold with said raised portions separating the same and generally parallel thereto thereby simulating spaced coils of a rope.

5. The method of claim 4 wherein the step of forming said spaced depressions includes the step of forming spaced depressions having spaced generally parallel sides, one of said sides terminating at on end in a point and at its other end curving to a point at one end of the other of said sides, the other of said sides having its other end curving to the pointed end of one of said sides.

6. The method of claim 1 wherein the step of placing sand uncured material into said mold includes the step of placing an uncured polymer material therein.

7. Apparatus for forming a decorative trim of cured material comprising:
an elongated mold of relatively solid and flexible material having a plurality of spaced raised and depressed portions in a cavity extending along one elongated side of said mold.

8. The apparatus of claim 7 wherein said mold is of elastomeric material.

9. The apparatus of claim 7 wherein said plurality of spaced depressions extend oblique to the longitudinal axis of said mold with raised portions separating the same and generally parallel thereto thereby simulating spaced coils of a rope.

10. The apparatus of claim 9 wherein each of said spaced depressions have spaced generally parallel sides, one of said sides terminating at one end in a point and at its other end curving to a point at one end of the other of said sides, the other of said sides having its other end curving to the pointed end of one of said sides.
